(19) United States
(12) Patent Application Publication
(10) Pub. No.: US 2019/0057334 A1
(43) Pub. Date: Feb. 21, 2019

(54) SYSTEM FOR EFFICIENTLY PROVIDING TAILORED SOLUTIONS TO FACILITATE EXECUTION OF PRIORITIES AND EVENTS

(71) Applicant: Bank of America Corporation, Charlotte, NC (US)

(72) Inventors: April Schneider, Charlotte, NC (US); Meredith Bouts McCormick, Charlotte, NC (US); Henry Agusti, Charlotte, NC (US); Malini Petersen, New York City, NY (US)

(21) Appl. No.: 15/896,414

(22) Filed: Feb. 14, 2018

Related U.S. Application Data
(60) Provisional application No. 62/548,220, filed on Aug. 21, 2017.

(51) Int. Cl. G06Q 10/06; G06N 5/04

(52) U.S. Cl. CPC G06Q 10/0637; G06N 5/04; G06Q 10/06311

(57) ABSTRACT

Embodiments of the present invention provide a system for providing tailored solutions to facilitate execution of priorities and events. The system is typically configured for extracting information associated with one or more resource pools of a user, extracting one or more plan conversations linked with the user, determining at least one priority based on the one or more plan conversations and the extracted information associated with the one or more resource pools, generating at least one tip associated with the at least one priority, display the at least one tip on a user device via a user interface, and in response to displaying the at least one tip, receiving one or more actions from the user.

### CROSS-REFERENCE OF RELATED APPLICATIONS

This application claims priority to U.S. Provisional Patent Application Ser. No. 62/548,220, filed Aug. 21, 2017, entitled “System for Efficiently Providing Tailored Solutions to Facilitate Execution of Priorities and Events,” the entirety of which is incorporated herein by reference.

### BACKGROUND

There is a need for a system to efficiently provide tailored solutions to facilitate execution of priorities and events.

### SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Embodiments of the present invention address the above needs and/or achieve other advantages by providing apparatuses (e.g., a system, a computer program product comprising computer program code stored on a non-transitory computer-readable medium which is readable by a computer, and/or other devices) and computer implemented methods for providing tailored solutions to facilitate execution of priorities and events, the system comprising a computer apparatus including a processor and a memory; and a module stored in the memory, comprising executable instructions that when executed by the processor cause the processor a computer apparatus including a processor and a memory; and a module stored in the memory, comprising executable instructions that when executed by the processor cause the processor to extract information associated with one or more resource pools of a user, extract one or more plan conversations associated with a user, determine, via an artificial intelligence engine, at least one priority based on the one or more plan conversations and the extracted information associated with the one or more resource pools, generate, via the artificial intelligence engine, at least one tip associated with the at least one priority, display the at least one tip via a user interface on a user device associated with the user, and in response to displaying the at least one tip, receive one or more actions from the user.

In some embodiments, the module further comprises executable instructions that when executed by the processor cause the processor to determine, via the artificial intelligence engine, that the extracted information associated with the one or more resource pools and the one or more plan conversations is not sufficient to identify the at least one priority, generate, via the artificial intelligence engine, a questionnaire based on the extracted information associated with the one or more resource pools, store the questionnaire in a data store, identify that the user has accessed the entity application, and in response to identifying that the user has accessed the entity application, extract the questionnaire stored in the data store and transmit control signals to the user device to display the questionnaire via the user interface.

In some embodiments, the module further comprises executable instructions that when executed by the processor cause the processor to receive one or more options associated with the questionnaire from the user device, wherein the user submits the one or more options to the questionnaire via the user interface, identify the at least one priority associated with the user based on the one or more options received from the user, generate, via the artificial intelligence engine, the at least one tip associated with the at least one priority, and display the at least one tip via the user interface on the user device.

In some embodiments, the module further comprises executable instructions that when executed by the processor cause the processor to set up at least one goal associated with the at least one priority based on determining the at least one priority.

In some embodiments, the module further comprises executable instructions that when executed by the processor cause the processor to monitor the progress of the at least one goal associated with the one priority and display the progress of the at least one goal via the user interface on the user device.

In some embodiments, the module further comprises executable instructions that when executed by the processor cause the processor to receive, via the user interface of the entity application, a user input from the user device associated with the a change in the at least one priority associated with the user, generate at least one new tip associated with the change based on receiving the user input from the user, and store the at least one new tip in the data store.

In some embodiments, the module further comprises executable instructions that when executed by the processor cause the processor to identify one or more events associated with the user, via an event service engine, based on the extracted information associated with the one or more resource pools or the one or more plan conversation, generate, via the artificial intelligence engine, at least one task associated with each of the one or more events, store the at least one task associated with each of the one or more events in the data store, identify that the user has accessed the entity application, in response to identifying that the user has accessed the entity application, extract the at least one task stored in the data store and display the at least one task, via the user interface, on the user device.

In some embodiments, the module further comprises executable instructions that when executed by the processor cause the processor to receive, via the user interface of the entity application, a user input from the user device associated with the a change in the one or more events associated with the user, generate at least one new task associated with the change based on receiving the user input from the user, and store the at least one new task in the data store.

In some embodiments, the module further comprises executable instructions that when executed by the processor cause the processor to identify a plurality of users assigned to each of the plurality of associates of the entity, extract historical activity from activity log associated with each of the plurality of users, wherein the historical activity is related to the at least one priority and the one or more events associated with each of the plurality of users, extract life plan details associated with each of the plurality of users, wherein the life plan details comprise at least one tip and the at least one task associated with the at least one priority and the one or more events, display the historical activity and the life plan details on an associate dashboard of an associate device, via a life plan associate interface, identify that a first associate of the plurality of associates has an appointment for a plan conversation with a first user of the plurality of users associated with the first associate, trigger one or more alerts associated with the historical activity and the life plan details associated with the first user on the associate dashboard, receive a life plan input, via the life plan associate interface, from the associate, wherein the life plan input is based on the plan conversation with the first user, and update the activity log associated with the first user based on the life plan input.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described some embodiments of the present invention in general terms, reference will now be made to the accompanying drawings, where:

FIG. 1 presents a life plan system environment, in accordance with one embodiments of the present invention;

FIG. 2, presents a block diagram illustrating a mobile device of a user and an associate illustrated in FIG. 1, in accordance with embodiments of the present invention;

FIG. 3 presents a block diagram illustrating a computing device of a user and an associate illustrated in FIG. 1, in accordance with embodiments of the present invention;

FIG. 4 presents a block diagram illustrating the entity system(s) of FIG. 1, in accordance with embodiments of the present invention;

FIG. 5 presents a block diagram illustrating the life plan system of FIG. 1, in accordance with embodiments of the present invention;

FIG. 6 presents a process flow for identifying one or more priorities associated with a user, in accordance with embodiments of the present invention; and

FIG. 7 presents a process flow for identifying one or more priorities associated with a user based on generating a questionnaire, in accordance with embodiments of the present invention;

FIG. 8 presents a process flow for generating a checklist after identifying one or more events associated with a user, in accordance with embodiments of the present invention;

FIG. 9 presents a process flow for dynamically adjusting life plan of a user, in accordance with embodiments of the present invention;

FIG. 10 presents a process flow for presenting information related to life plan of a plurality of users to an associate, in accordance with embodiments of the present invention;

FIG. 11A presents a screenshot of a life plan user interface enabled by embodiments of the present invention;

FIG. 11B presents a screenshot of a life plan user interface enabled by embodiments of the present invention;

FIG. 11C presents a screenshot of a life plan user interface enabled by embodiments of the present invention;

FIG. 12 presents a screenshot of a life plan associate interface enabled by embodiments of the present invention;

FIG. 13 represents a screenshot of a life plan user interface enabled by embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” may include any organization that processes financial transactions including, but not limited to, banks, credit unions, savings and loan associations, investment companies, stock brokerages, asset management firms, insurance companies and the like. In accordance with embodiments of the invention, the terms “third party system” and “other third party systems” may include any organizations including, but not limited to, photo identification issuing agencies, network managing organizations, email managing organizations, and/or the like. Furthermore, embodiments of the present invention use the term “user” or “customer.” It will be appreciated by someone with ordinary skill in the art that the user or customer may be a customer of the financial institution or a potential customer of the financial institution or an employee of the financial institution.

In accordance with embodiments of the invention, a “resource pool” or an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

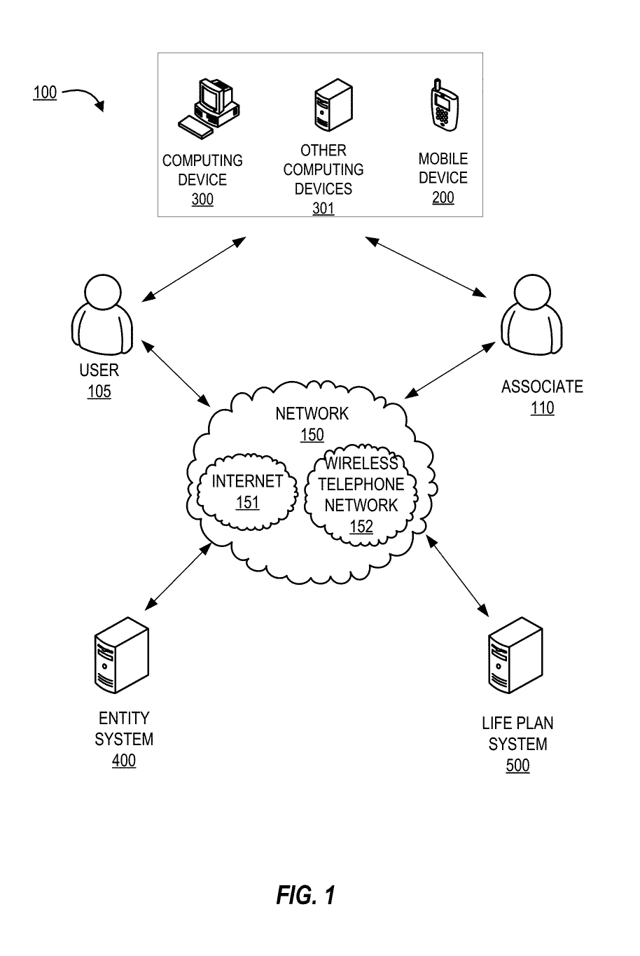

FIG. 1 provides a block diagram illustrating an environment 100 for a life plan system. As depicted in the embodiment of FIG. 1, the operating environment 100 may include a life plan system 500 interacting with an entity system 400, a user 105, an associate 110, using a network 150. In some embodiments, the life plan system 500 may be maintained by the entity. In some embodiments, the life plan system 500 may be owned by the entity and maintained by a third party. In some embodiments, the life plan system 500 may be a part of the entity system 400. In some embodiments, the user 105 may be customer of the entity. In some embodiments the associate 110 may an employee of the entity. For example, associate may be a financial solutions advisor, a customer care associate, a lending specialist, and/or the like. In some embodiments, the system environment may include other third party systems and other entity systems. In some embodiments, the life plan system 500 may interact simultaneously with a plurality of users and a plurality of associates associated with the entity.

The environment 100 also may include a plurality of user devices. The user devices may include any machine, apparatus, system or the like that may be connected to and communicate with other devices over a network 150. At least one of the devices may include a computing device 300, other computing devices 301, and a mobile device 200 for use by the user 105 and the associate 110. The computing devices 301 may be any device that employs a processor and memory and can perform computing functions, such as a computing device 300 or a mobile device 200, that may be connected to or access the network 150. The computing device 300 may include a personal computer such as a desktop computer, laptop computer, tablet or any type of computing device that may be connected to a network by landline or wireless access such as wireless local area network (WLAN) such as Wi-Fi based on the Institute of Electrical and Electronics Engineers' (IEEE) 802.11 standards, Bluetooth short-wavelength UHF radio waves in the ISM band from 2.4 to 2.485 GHz or other wireless access technology. As used herein, the mobile device 200 may include any mobile communication device, such as a cellular telecommunications device (i.e., a cell phone or mobile phone), personal digital assistant (PDA), a mobile Internet accessing device, tablet computer, or other mobile device. A mobile device may connect to the network by a cellular telecommunications network or by Wi-Fi, Bluetooth or other access technology.

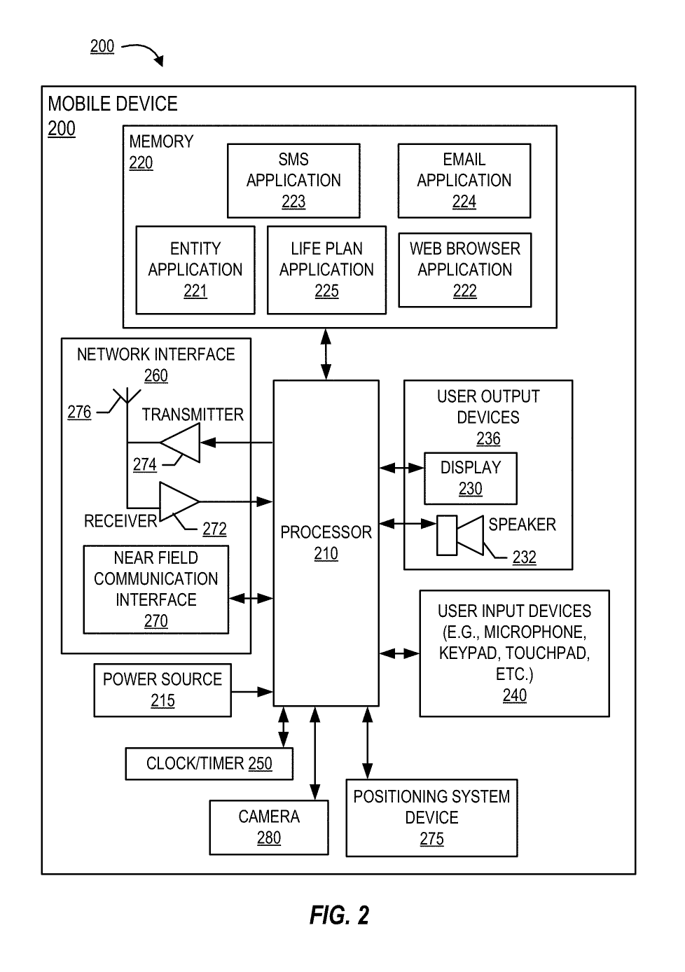

FIG. 2 provides a block diagram illustrating a user's mobile device 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, Global Positioning Systems (GPS) devices, or any combination of the aforementioned. In some embodiments, the mobile device may be a wearable device.

Some embodiments of the mobile device 200 include a processor 210 communicably coupled to such devices as a memory 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as e-mail application 224 and SMS application 223.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

The network interface 260 may also include a near field communication (NFC) interface 270. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 270 may include a smart card, key card, proximity card, Bluetooth® device, radio frequency identification (RFID) tag and/or reader, transmitter, receiver, and/or the like. In some embodiments, the NFC interface 270 communicates information via radio, infrared (IR), and/or optical transmissions. In some embodiments, the NFC interface 270 is configured to operate as an NFC transmitter and/or as an NFC receiver (e.g., an NFC reader). Also, it will be understood that the NFC interface 270 may be embedded, built, carried, and/or otherwise supported in and/or on the mobile device 200. In some embodiments, the NFC interface 270 is not supported in and/or on the mobile device 200, but the NFC interface 270 is otherwise operatively connected to the mobile device 200 (e.g., where the NFC interface 270 is a peripheral device plugged into the mobile device 200). Other apparatuses having NFC interfaces mentioned herein may be configured similarly. In some embodiments, the NFC interface 270 of the mobile device 200 is configured to contactlessly and/or wirelessly communicate information to and/or from a corresponding NFC interface of another apparatus (e.g., a wearable device or another mobile or computing device).

As described above, the mobile device 200 has a user interface that may be made up of user output devices 236 and/or user input devices 240. The user output devices 236 include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s). The user interface may also include a camera 280, such as a digital camera.

The mobile device 200 may also include a positioning system device 275 that is configured to be used by a positioning system to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a location to determine that the mobile device 200 is located proximate these known devices.

The memory 220 is operatively coupled to the processor 210. As used herein, “memory” or “memory device” includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

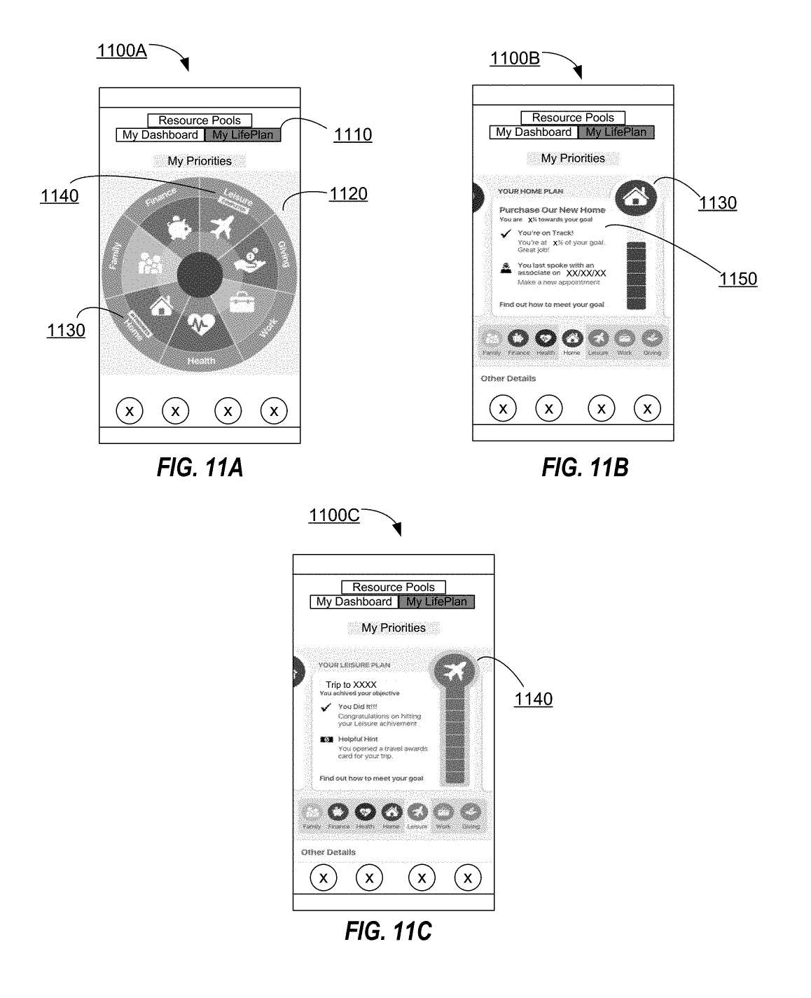

The memory 220 can store any of a number of applications which include computer-executable instructions/code executed by the processor 210 to implement the functions of the mobile device 200 and/or one or more of the process/method steps described herein. The memory 220 includes an entity application 221 that may be used to allow communication with an entity system such as the entity system 400 and/or the smart devices to implement the system of the invention. The use of the entity application 221 may facilitate access to the system of the invention by providing log-in systems including user authentication systems, account information, system controls or the like. The memory 220 includes a life plan application 225 that may be used to communicate with the life plan system 500. The entity application 221 and life plan application 225 communicate with the life plan system 500 and the entity system 400 to allow the user to set up and/or control the system of the invention. In some embodiments, the entity application 221 is an online banking application. In some embodiments, the entity application 221 and life plan application 225 are part of a single application. For example, the entity application 221 may be an online banking application and the life plan application 225 may be a module in the online banking application as illustrated in FIG. 11A through 11C. In some embodiments, wherein the user is a new customer or a first time user of the entity application 221 and when the user installs the entity application 221, the life plan application 225 is automatically embedded within the entity application 221.

These applications also typically provide a graphical user interface (GUI) on the display 230 that allows the associate 110 and the user 105 to communicate with the mobile device 200, the entity system 400 and/or other devices or systems. For example, the life plan application 225 and the entity application 221 may provide a life plan user interface for the user 105 and a life plan associate interface for the associate 110. The life plan application 225 installed on user devices such as the mobile device 200 may provide different functions and different interfaces to the user 105 and the associate 110 to perform one or more steps of process flows described herein. The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user authentication information.

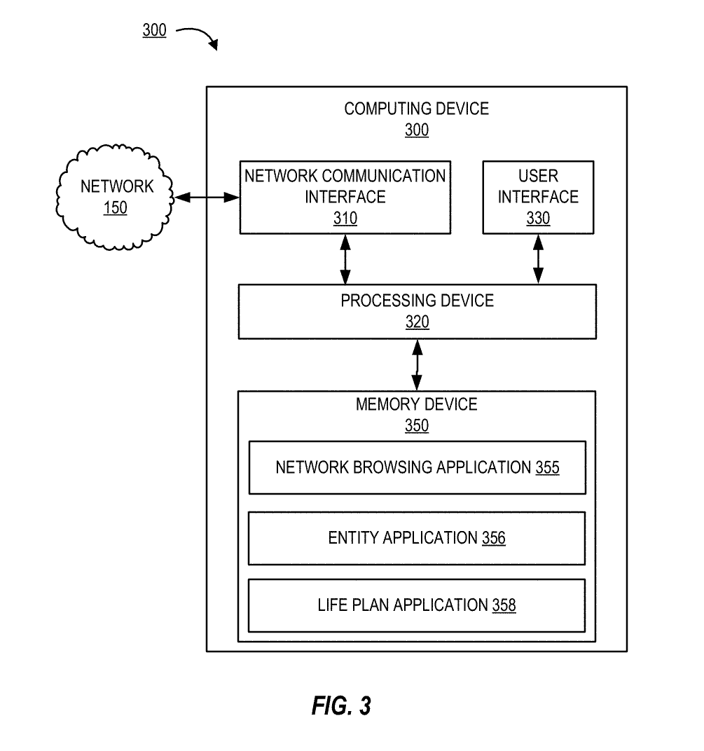

Referring now to FIG. 3, the computing device 300 also includes various features, such as a network communication interface 310, a processing device 320, a user interface 330, and a memory device 350. The network communication interface 310 includes a device that allows the computing device 300 to communicate over the network 150 (shown in FIG. 1). In one embodiment of the invention, a network browsing application 355 provides for a user to establish network communication with an entity system 400 and life plan system 500.

As used herein, a “processor” or “processing device,” such as the processing device 320, generally refers to a device or combination of devices having circuitry used for implementing the communication and/or logic functions of a particular system. For example, a processing device 320 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 320 may further include functionality to operate one or more software programs based on computer-executable program code thereof, which may be stored in memory device 350. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of interface devices and/or software that allow a customer to input commands and data to direct the processing device to execute instructions. For example, the user interface 330 presented in FIG. 3 may include a graphical user interface (GUI) or an interface to input computer-executable instructions that direct the processing device 320 to carry out specific functions. In one exemplary embodiment of the present invention, the graphical user interface may be a life plan user interface for the user 105 or a life plan associate interface for the associate 110 provided by the system to receive input and display information to the user 105 and the associate 110. The user interface 330 employs certain input and output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory device 350 includes any computer memory that provides an actual or virtual space to temporarily or permanently store data and/or commands provided to the processing device 320 when it carries out its functions described herein. The memory device 350 may include such applications as a conventional network browsing application 355, an entity application 356, a life plan application 358 and/or the like. The entity application 356 may be used to allow communication with an entity system, such as the entity system 400. The life plan application 358 may be used to allow communication with the life plan system 500 and the entity system 400 to implement one or more actions. The other computing devices 301 as shown in FIG. 1 may include similar system blocks as the computing device 300.

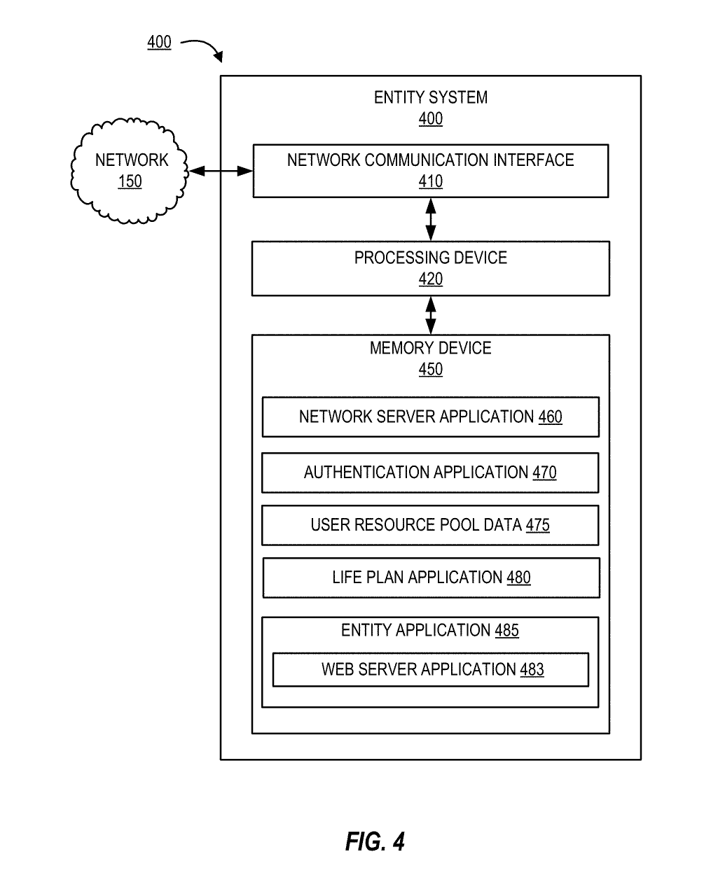

FIG. 4 provides a block diagram illustrating the entity system 400, in greater detail, in accordance with embodiments of the invention. As illustrated in FIG. 4, in one embodiment of the invention, the entity system 400 includes one or more processing devices 420 operatively coupled to a network communication interface 410 and a memory device 450. In certain embodiments, the entity system 400 is operated by an entity, such as a financial institution.

It should be understood that the memory device 450 may include one or more databases or other data structures/repositories. In one embodiments of the present invention, the memory device 450 includes data stores comprising information about one or more resource pools associated with a plurality of users associated with the entity. The memory device 450 also includes computer-executable program code that instructs the processing device 420 to operate the network communication interface 410 to perform certain communication functions of the entity system 400 described herein. For example, in one embodiment of the entity system 400, the memory device 450 includes, but is not limited to, a network server application 460, an authentication application 470, user resource pool data 475, a life plan application 480, an entity application 485 including a mobile web server application 483, and other computer-executable instructions or other data. The computer-executable program code of the network server application 460, the authentication application 470, life plan application 480, or the entity application 485 may instruct the processing device 420 to perform certain logic, data-processing, and data-storing functions of the entity system 400 described herein, as well as communication functions of the entity system 400. The entity application 485 communicates with the user devices to facilitate communication between the user and the entity. The entity application 485 may be a mobile banking application. In one embodiment, the life plan application 480 may be a part of the entity application 485.

In one embodiment, the network server application 460, the authentication application 470, and the entity application 485 are configured to invoke or use the customer authentication data stored in the memory when authenticating a user to the entity system 400. In some embodiments, the life plan application 480 allows communication with the life plan system 500. The user resource pool data 475 comprises information of all resource pools of a plurality of users associated with the entity managing the entity system 400.

As used herein, a “communication interface” generally includes a modem, server, transceiver, and/or other device for communicating with other devices on a network. The network communication interface 410 is a communication interface having one or more communication devices configured to communicate with one or more other devices on the network 150, such as the mobile device 200, the computing device 300, other computing devices 301, and life plan system 500. The processing device 420 is configured to use the network communication interface 410 to transmit and/or receive data and/or commands to and/or from the other devices connected to the network 150.

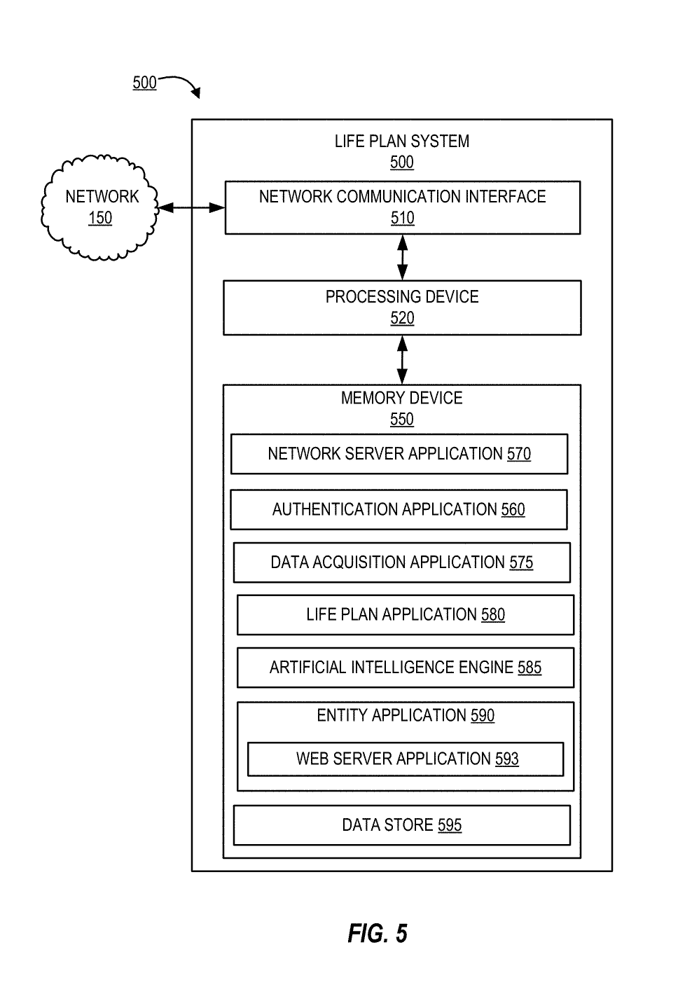

FIG. 5 presents a block diagram illustrating the life plan system 500, in accordance with embodiments of the invention. As illustrated in FIG. 4, in one embodiment of the invention, the life plan system 500 includes one or more processing devices 520 operatively coupled to a network communication interface 510 and a memory device 550. In certain embodiments, the life plan system 500 is operated by an entity, such as a financial institution.

It should be understood that the memory device 550 may include one or more databases or other data structures/repositories. The memory device 550 also includes computer-executable program code that instructs the processing device 520 to operate the network communication interface 510 to perform certain communication functions of the life plan system 500 described herein. For example, in one embodiment of the life plan system 500, the memory device 550 includes, but is not limited to, a network server application 570, an authentication application 560, a data acquisition application 575, a life plan application 580, an artificial intelligence engine 585, a data store 595 and an entity application 590 including a web server application 593, and other computer-executable instructions or other data. The computer-executable program code of the network server application 570, the authentication application 560, the data acquisition application 575, the life plan application 580, the artificial intelligence engine 585, the entity application 590, or the web server application 593 may instruct the processing device 520 to perform certain logic, data-processing, and data-storing functions of the life plan system 500 described herein, as well as communication functions of the life plan system 500. The entity application 590 and the life plan application 580 may be part of the same application. The data acquisition application 575 communicates with the entity system 400 to extract resource pool data associated with a plurality of users. The life plan application 580 or the entity application 590 communicate with the entity application 221 or the life plan application 225 in the mobile device 200 and entity application 356 or life plan application 358 in the computing device 300 to facilitate one or more steps in the process flows described herein. The data store 595 may include life plan data associated with the plurality of users.

As used herein, a “communication interface” generally includes a modem, server, transceiver, and/or other device for communicating with other devices on a network. The network communication interface 510 is a communication interface having one or more communication devices configured to communicate with one or more other devices on the network 150, such as the mobile device 200, the computing device 300, and/or other computing devices 301. The processing device 520 is configured to use the network communication interface 510 to transmit and/or receive data and/or commands to and/or from the other devices connected to the network 150.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

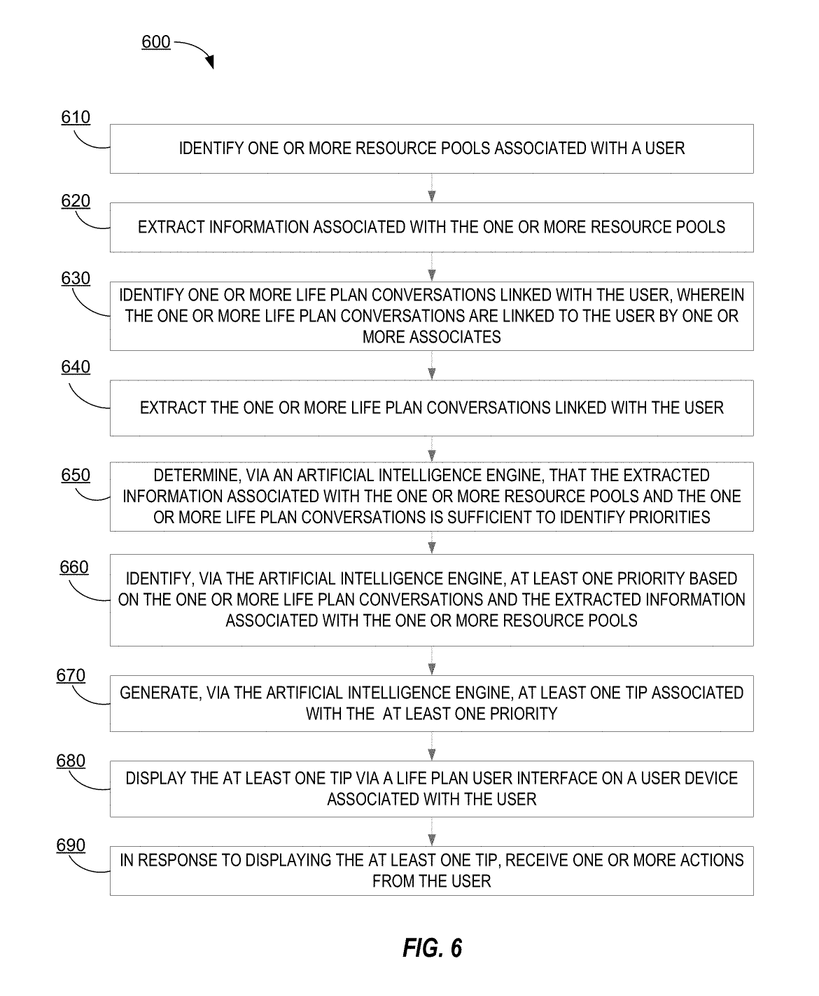

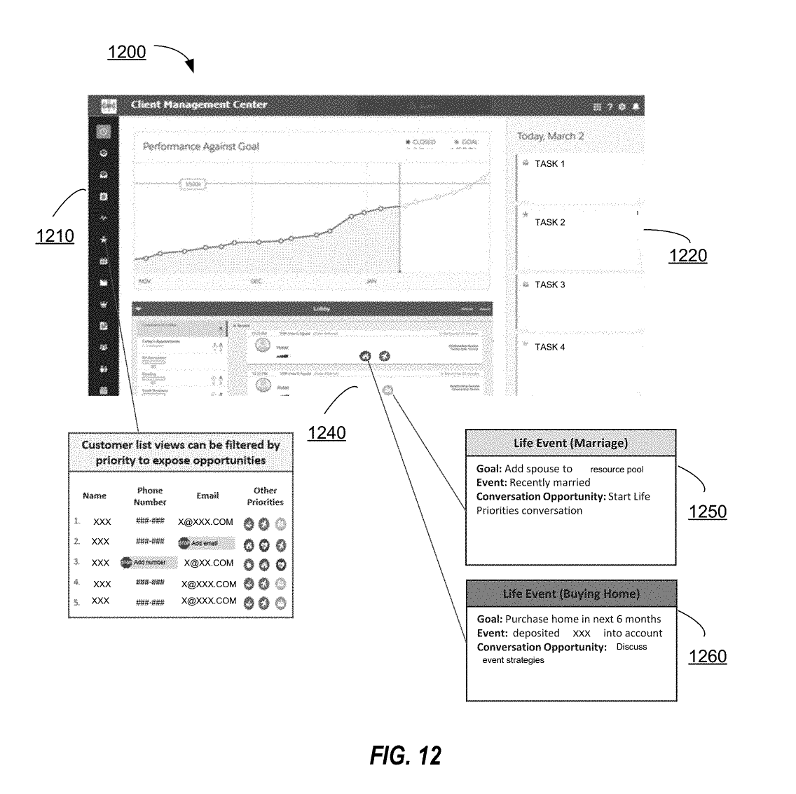

FIG. 6 presents a process flow 600 for identifying one or more priorities associated with a user. As shown in block 610, the system identifies one or more resource pools associated with a user. The resource pools may be any accounts associated with the user. For example, the resource pool may be checking account, savings account, investment account, money market savings account, and/or the like. As shown in block 620, the system extracts information associated with the one or more resource pools. For example, the system extracts historical transactions linked with the accounts of the user. The information associated with the one or more resource pools may be stored in the memory 450 of the entity system 400. The system may communicate with the entity system using the network communication interface 510. As shown in block 630, the system identifies one or more life plan conversations linked with the user, wherein the one or more life plan conversations are linked to the user by one or more associates. In one exemplary embodiment, the user visits a financial center to update his/her account and shares that he/she is interested in travelling. This conversation is documented or recorded by an associate and is linked to the user. In another exemplary embodiment, the user schedules an appointment with a financial advisor to discuss about buying a new house. The financial advisor may document the conversation using a life plan associate interface as shown in FIG. 12 and link it to the user. As shown in block 640, the system extracts the one or more life plan conversations linked with the user.

As shown in block 650, the system determines, via the artificial intelligence engine 585, that the extracted information associated with the one or more resource pools and the one or more life plan conversations is sufficient to identify priorities. For example, the artificial intelligence engine determines whether any of the recent transactions associated with the user are significant and if there are any life plan conversations linked with the user.

As shown in block 660, the system identifies, via the artificial intelligence engine 585, at least one priority based on the one or more life plan conversations and the extracted information associated with the one or more resource pools. For example, the system identifies that the user has recently deposited some resources into a money market savings account and also identifies that the user had a life plan conversation with an associate about buying a house. Based on this information, the system may identify that the user may be savings towards “Home” life priority. Life priorities may be divided into any number of categories. In one exemplary embodiment of the present invention, the life priorities are divided into seven categories such as “Home,” “Finance,” “Health,” “Giving,” “Leisure,” “Family,” and “Work”. In some embodiments, the user is given an option to add more categories to the already existing categories. In some embodiments, the user is given an option to change or modify the existing categories. In some embodiments, the user may indicate during a life plan conversation that the user is interested in travelling and buying a home. In such an embodiment, the system may identify that the user may have two life priorities i.e., “Home” and “Leisure”. Upon identifying at least one priority associated with the user, the system may store this information about life priorities in a profile of the user and present this information via a life plan user interface on a user device as shown in FIGS. 11A, 11B, and 11C. In some embodiments, the system may use social networking information to identify the at least one priority. In some embodiments, the system may use information from email accounts or any such accounts to identify the at least one priority. In some embodiments, the system in response to identifying the at least one priority, displays it to the user via the life plan user interface.

As shown in block 670, the system generates, via the artificial intelligence engine 585, at least one tip associated with the at least one priority. For example, the system may identify that “Leisure” is associated with the user and may generate travel tips. In another example, the system may identify that “Home” is associated with the user and may generate tips about mortgage payments and follow up appointments with an associate to discuss mortgage payment options. In some embodiments, the system may set goals associated with the at least one priority automatically. For example, when the system identifies the priority “home” the system may set a goal to purchase home in next 6 months. In alternate embodiments, the system may allow the user to update and set goals. As shown in block 680, the system displays the at least one tip via the life plan user interface on the user device associated with the user. The user device may be a mobile device or a personal computing device. As shown in block 690, the system in response to displaying the at least one tip, receives one or more actions from the user. For example, the system may display a hint or a tip on the life plan user interface about upgrading to a travel rewards card. Upon receiving this tip, the user may initiate a series of actions via the life plan user interface to book an appointment with a specialist.

The system may monitor the progress of the goal and the at least one priority and display the progress of the goal and at least one priority via the life plan user interface. Additionally, the system may also compare the progress of the at least one priority associated with the user and may compare the progress with one or more users associated with the entity and display the results of comparison to the use via the life plan user interface. The one or more users may be contacts of the user, wherein the one or more users are customers of the entity. In some embodiments, the system may identify the one or more users by accessing the contacts of the user via the entity application 221. In other embodiments, the system may identify the one or more users by using the information from email accounts or social networking accounts of the user. The system may identify that a goal associated with the at least one priority has been met and may push a notification to the user device via the life plan user interface, wherein the notification comprises a message that the goal has been completed by the user.

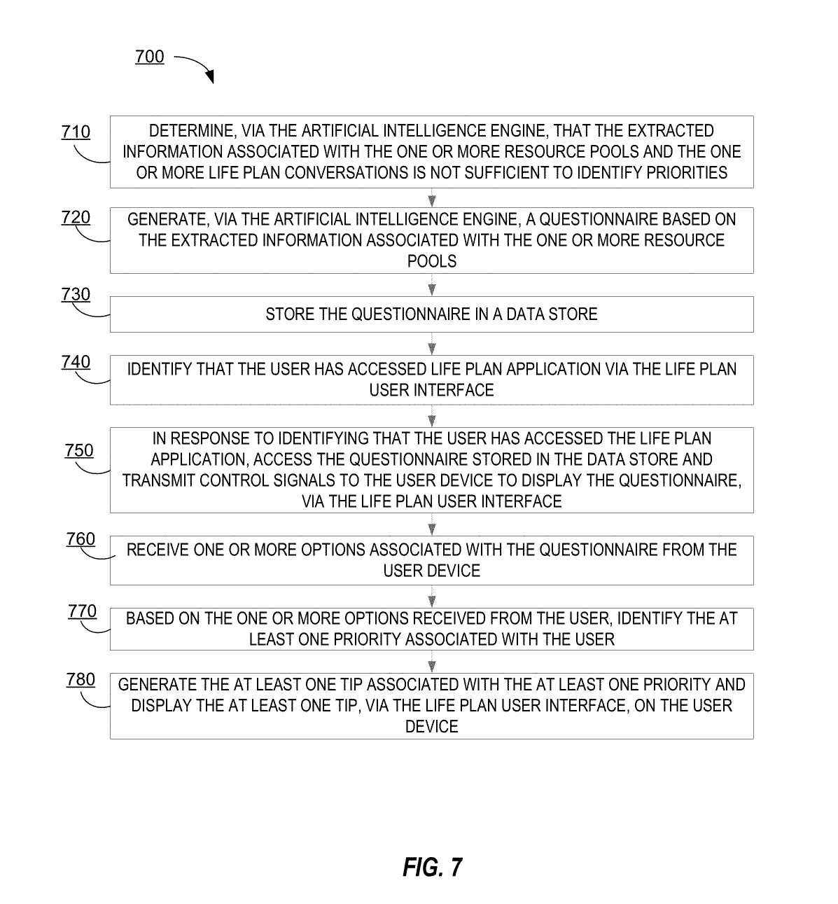

FIG. 7 presents a process flow 700 for identifying one or more priorities associated with a user based on generating a questionnaire. As shown in block 710, the system determines, via the artificial intelligence engine 585, that the extracted information associated with the one or more resource pools as shown in block 620 and the one or more life plan conversations as shown in block 640 is not sufficient to identify priorities. For example, the system may not identify any significant transactions or any prior life plan conversations associated with the user. In another example, the system may identify that the user has expressed interest in travel, buying a home, saving for health, and/or the like during life plan conversations with one or more associates. In such a case, the system may be not able to determine what priorities the user may be saving for.

As shown in block 720, the system may generate, via the artificial intelligence engine 585, a questionnaire based on the extracted information associated with the one or more resource pools. For example, the system may identify that the user has deposited resources into the money market savings account and may generate a questionnaire such as “what are you saving towards?” The system may also provide options such as “buying a home,” “travel,” “buying a car,” “graduate school,” and/or the like. As shown in block 730, the system may store the questionnaire in the data store 595.

As shown in block 740, the system identifies that the user has accessed life plan application, via the life plan user interface. For example, as shown in FIG. 11A, the user may log in to the mobile banking application 221 and may select “My LifePlan” tile. Selection of this tile may trigger a series of steps as shown in block 750. The system, in response to identifying that the user has accessed the life plan application, accesses the questionnaire stored in the data store 595 and transmits control signals to the user device to display the questionnaire via the life plan user interface.

As shown in block 760, the system receives one or more options associated with the questionnaire from the user device. For example, when the system displays the question “what are you saving towards?” the user may select “buying a home” and “travel” and submit it to the system. As shown in block 770, the system based on receiving the one or more options received from the user, identifies the at least one priority associated with the user. For example, based on receiving the above mentioned options, the system may determine two life priorities “Home” and “Leisure” associated with the user. As shown in block 780, the system may generate the at least one tip as discussed in block 680 and display it on the user device. Upon receiving the tip, the user may initiate one or more actions as discussed in block 690.

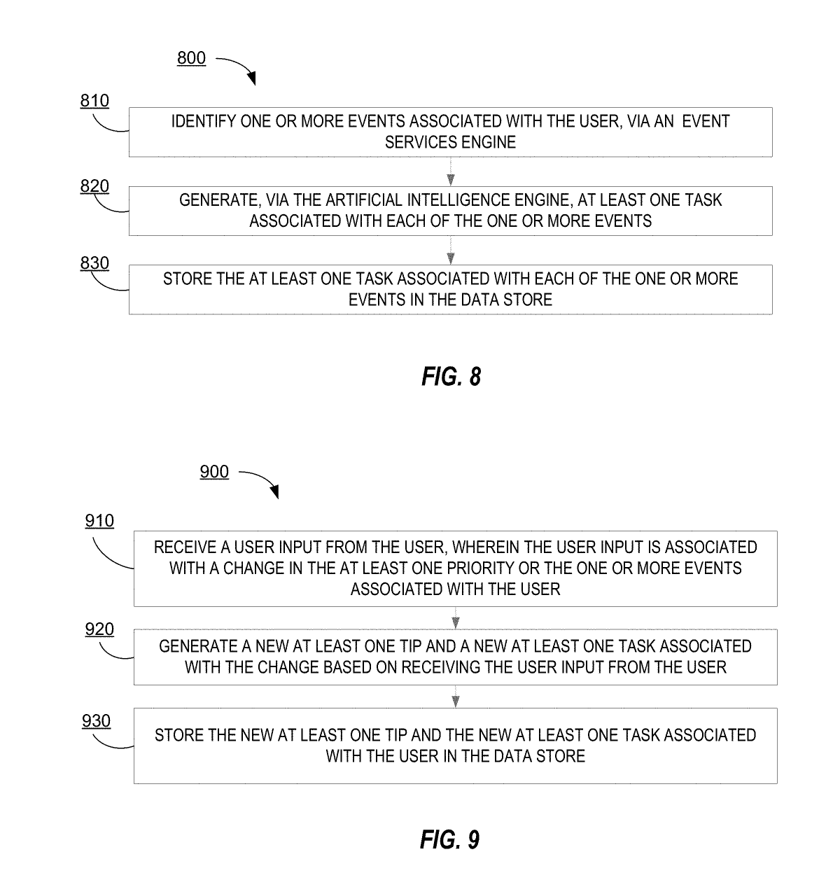

FIG. 8 presents a process flow 800 for generating a checklist after identifying one or more events associated with a user. As shown in block 810, the system identifies one or more events associated with the user, via an event services engine (not shown). The event services engine may identify life events such as “job change,” “marriage/divorce,” “welcome a child,” “buy/sell home,” “upcoming travel,” “retirement,” “end of life,” and/or the like. The event services engine based on the extracted information associated with the one or more resource pools may identify the one or more events. For example, the event services engine may identify that one or more transactions associated with the resource pools are related to buying a crib and other baby related products and may predict the event “welcome a child.” In some cases, the system may periodically prompt the user, via the life plan user interface, to identify any upcoming events. In some embodiments, the system may identify the one or more events based on social networking information associated with the user. For example, the system may identify the event “job change” based on identifying that the user has updated job title or employer in the social networking page. In some other embodiments, the system may identify the one or more events based on information in the email accounts of the user. For example, the system may identify the event “upcoming travel” by accessing travel itinerary of the user from the email account of the user. In some embodiments, the system in response to identifying the one or more events, displays it to the user via the life plan user interface.

As shown in block 820, the system based on identifying the one or more events, generates, via the artificial intelligence engine, at least one task associated with each of the one or more events. For example, the system identifies that the user is about to experience “a job change” and may create a list of tasks such as updating addresses associated with one or more accounts of the user and/or the like. In another example, wherein the event is identified as marriage, the system may create a list of tasks including adding spouse to one or more accounts of the user, opening a joint account, ordering a new debit card, and/or the like. In yet another example, wherein the event is end of life, the system may generate a list of tasks including updating will, preparation of power of attorneys, and/or the like. In some embodiments, the system may prepare a checklist including the at least one task.

As shown in block 830, the system stores the at least one task associated with each of the one or more events in the data store. In one embodiment, the system identifies that the user has an appointment with a specialist and presents the at least one task associated with the user on an associate dashboard as shown in FIG. 12, via the life plan associate interface. In some embodiments, the system may present the at least one task to the user on the user device, via the life plan user interface. In such an embodiment, when the user performs the at least one task, the system marks the at least one task as completed and presents the progress of the checklist on the user device via the life plan user interface.

FIG. 9 presents a process flow 900 for dynamically adjusting life plan of a user. As shown in block 910, the system receives a user input from the user, wherein the user input is associated with a change in the at least one priority or the one or more events associated with the user. In some embodiments, the user may input the change via the life plan user interface. In alternate embodiments, the associate may input the change via the life plan associate interface. As shown in block 920, the system generates a new at least one tip and a new at least one task associated with the change based on receiving the user input from the user. As shown in block 930, the system stores the new at least one tip and the new at least one task associated with the user in the data store, which may be presented to the user via the life plan user interface and the associated via the life plan associate interface.

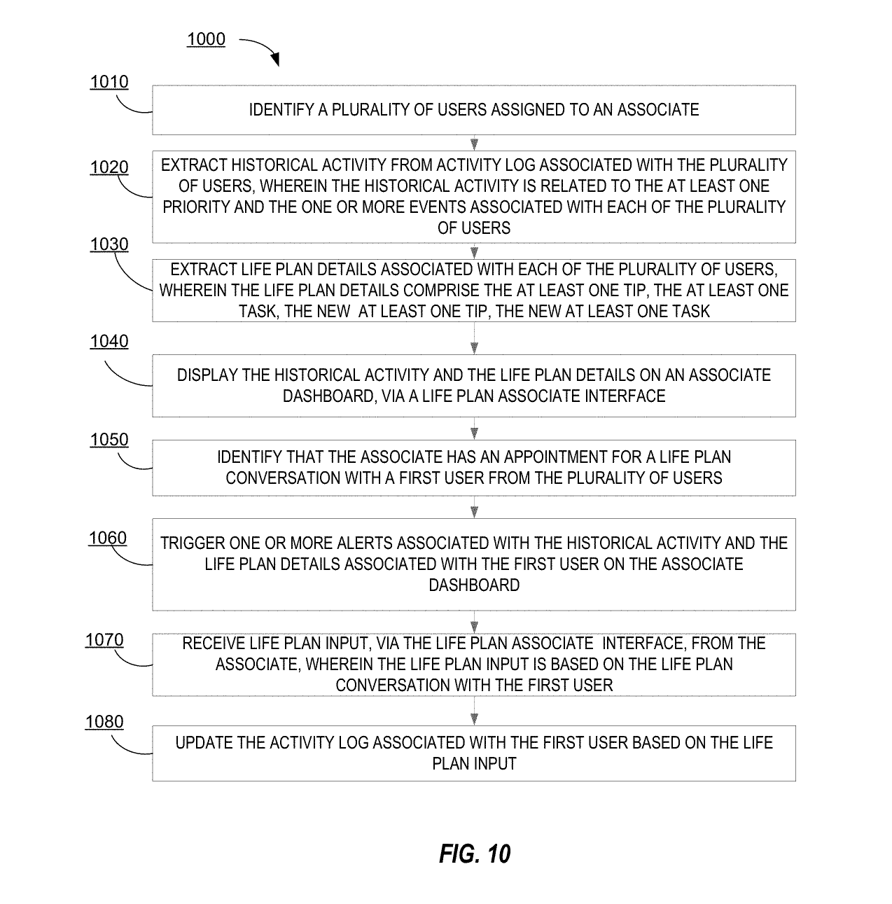

FIG. 10 presents a process flow 1000 for presenting information related to life plan of a plurality of users to an associate. As shown in block 1010, the system identifies a plurality of users assigned to an associate. The associate may be a financial advisor, a lending specialist, a customer care representative, and/or the like. Based on the user's priorities and events, in some embodiments, the system may automatically assign an associate to the user. In alternate embodiments, the user choose an associate based on his/her priorities and events.

As shown in block 1020, the system extracts historical activity from activity log associated with the plurality of users, wherein the historical activity is related to the at least one priority and the one or more events associated with each of the plurality of users. The activity log may include details of past life plan conversations associated with the user. As shown in block 1030, the system extracts life plan details associated with each of the plurality of users, wherein the life plan details comprises the at least one tip, the at least one task, the new at least one tip, or the new at least on task. As shown in block 1040, the system displays the historical activity and the life plan details on the associate dashboard, via the life plan associate interface. For example, the system may extract information associated with past life plan conversations the user may have had with other associates and also a list of tasks or tips such opening of a new joint account, upgrading to a travel rewards card, and/or the like and presents it on the associate dashboard. This provides the associate with all required information associated with the plurality of users assigned to him/her.

As shown in block 1050, the system identifies that the associate has an appointment for a life plan conversation with a first user from the plurality of users. For example, the first user may have booked an appointment with the associate to discuss mortgage options. As shown in block 1060, trigger one or more alerts associated with the historical activity and the life plan details associated with the first user on the associate dashboard as shown in FIG. 12. For example, the system may triggers alerts such as “discuss mortgage options,” “discuss opening a combined account,” “discuss upgrading to travel rewards card” and/or the like. The associate may ask the user, during the life plan conversation about the one or more alerts.

As shown in block 1070, the system receives life plan input, via the life plan associate interface, from the associate, wherein the life plan input is based on the life plan conversation with the first user. For example, the user may indicate interest in travel or may indicate about future travel plans during the life plan conversation with the associate. The associate records the life plan conversation and may submit it to the system. As shown in block 1080, the system updates the activity log associated with the first user based on the life plan input received from the associate. The system, using the activity log, identifies new priorities as discussed in FIG. 6.

FIG. 11A presents a life plan user interface 1100A on a mobile device of the user. As shown in the FIG. 11A, My LifePlan tile 1110 is included as a tab in the mobile banking application of the user. When the user selects My LifePlan tab 1110, the system displays a list of priorities and their progress as shown in 1120. The priority “Leisure” associated with the user is displayed as completed and the priority “Home” 1130 associated with the user is displayed as in progress. FIG. 11B presents life plan user interface 1100B associated with the progress of priority “Home” 1130. The tips associated with the priority “Home” 1130 are displayed under your home plan as shown in 1150. FIG. 11C presents life plan user interface 1100C associated with the progress of priority “Leisure” 1140. It should be noted that the embodiment described with respect to FIGS. 11A-11C are provided as illustrative only. It is envisioned that many different tools, services, windows and interfaces may be generated to display the information shown in FIGS. 11A through 11C.

FIG. 12 presents a life plan associate interface 1200 on a computing device or a mobile device of an associate. The associate dashboard 1210 comprises a list of updates 1220 provided by the system such as assignment of a new lead, upcoming appointment, and/or the like. The lobby 1240 comprises various priorities and life events such as marriage 1250 and buying home 1260 associated with the first user. The system also displays conversation opportunities associated with each event. It should be noted that the embodiment described with respect to FIG. 12 is provided as illustrative only. It is envisioned that many different tools, services, windows and interfaces may be generated to display the information shown in FIG. 12.

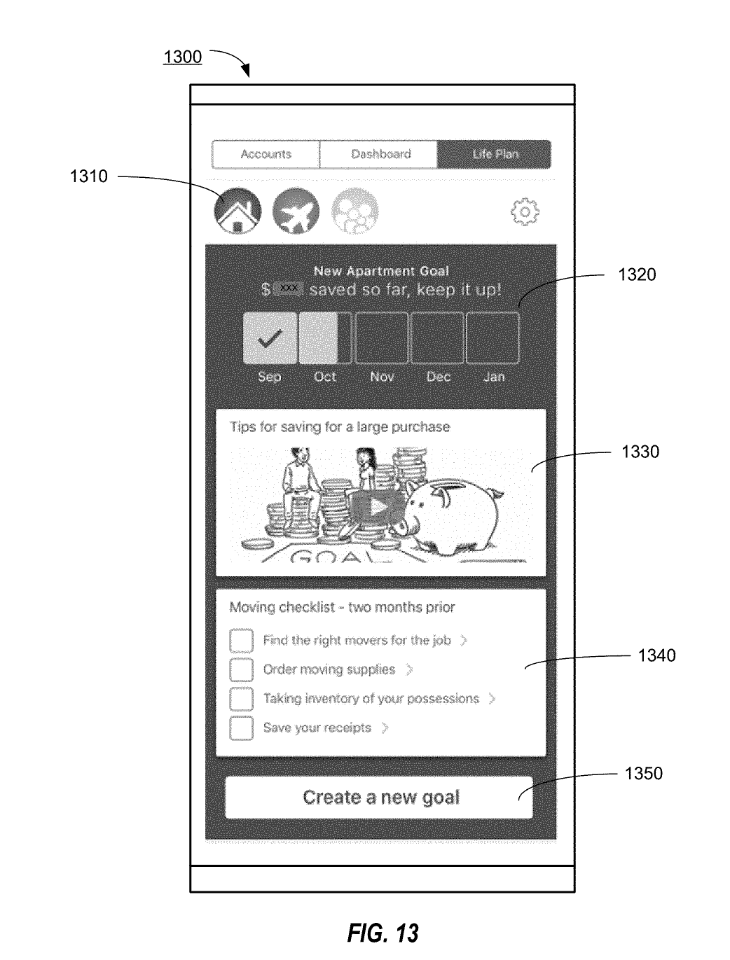

FIG. 13 presents a life plan user interface 1300 on a computing device or a mobile device of a user. As shown in FIG. 13, the life plan user interface has three different tabs “accounts,” “dashboard,” “life plan.” Upon selecting the “life plan” tab, the system may present a list of priorities 1310 associated with the user and in this example, the list of priorities include “home,” “leisure,” “family.” The system may present information related to a goal associated with a priority of the list of priorities and the system may also present the progress of the goal as shown in 1320. As shown in 1330, the system may present a tip associated with any of the list of priorities. The system may further include a checklist associated with any of the events as described above in FIG. 8 and is represented by 1340 in FIG. 13. Additionally, the system may include an option allowing the user to create a new goal as shown in 1350. It should be noted that the embodiment described with respect to FIG. 13 is provided as illustrative only. It is envisioned that many different tools, services, windows and interfaces may be generated to display the information shown in FIG. 13. Any of the features described herein may be represented on a user interface utilizing any of the graphical user interface builders or interface development tools.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing tailored solutions to facilitate execution of priorities and events, wherein the system provides a user interface and an associate interface and the system comprises:
a computer apparatus including a processor and a memory; and
a module stored in the memory, comprising executable instructions that when executed by the processor cause the processor to:
identify one or more resource pools associated with a user of an entity;
extract information associated with the one or more resource pools of the user;
identify one or more plan conversations linked with the user, wherein the one or more plan conversations are linked to the user by a plurality of associates of the entity;
extract the one or more plan conversations associated with the user;
determine, via an artificial intelligence engine, at least one priority based on the one or more plan conversations and the extracted information associated with the one or more resource pools;
generate, via the artificial intelligence engine, at least one tip associated with the at least one priority;
display the at least one tip via a user interface on a user device associated with the user, wherein the user interface is associated with an entity application; and
in response to displaying the at least one tip, receive one or more actions from the user.

2. The system of claim 1, wherein the module further comprises executable instructions that when executed by the processor cause the processor to:
determine, via the artificial intelligence engine, that the extracted information associated with the one or more resource pools and the one or more plan conversations is not sufficient to identify the at least one priority;
generate, via the artificial intelligence engine, a questionnaire based on the extracted information associated with the one or more resource pools;
store the questionnaire in a data store;
identify that the user has accessed the entity application; and
in response to identifying that the user has accessed the entity application, extract the questionnaire stored in the data store and transmit control signals to the user device to display the questionnaire via the user interface.

3. The system of claim 2, wherein the module further comprises executable instructions that when executed by the processor cause the processor to:
receive one or more options associated with the questionnaire from the user device, wherein the user submits the one or more options to the questionnaire via the user interface;
identify the at least one priority associated with the user based on the one or more options received from the user;
generate, via the artificial intelligence engine, the at least one tip associated with the at least one priority; and
display the at least one tip via the user interface on the user device.

4. The system of claim 1, wherein the module further comprises executable instructions that when executed by the processor cause the processor to set up at least one goal associated with the at least one priority based on determining the at least one priority.

5. The system of claim 4, wherein the module further comprises executable instructions that when executed by the processor cause the processor to monitor progress of the at least one goal associated with the at least one priority and display the progress of the at least one goal via the user interface on the user device.

6. The system of claim 1, wherein the module further comprises executable instructions that when executed by the processor cause the processor to:
receive, via the user interface of the entity application, a user input from the user device associated with the a change in the at least one priority associated with the user;
generate at least one new tip associated with the change based on receiving the user input from the user; and
store the at least one new tip in the data store.

7. The system of claim 1, wherein the module further comprises executable instructions that when executed by the processor cause the processor to:
identify one or more events associated with the user, via an event service engine, based on the extracted information associated with the one or more resource pools or the one or more plan conversation;
generate, via the artificial intelligence engine, at least one task associated with each of the one or more events;
store the at least one task associated with each of the one or more events in the data store;
identify that the user has accessed the entity application;
in response to identifying that the user has accessed the entity application, extract the at least one task stored in the data store and display the at least one task, via the user interface, on the user device.

8. The system of claim 7, wherein the module further comprises executable instructions that when executed by the processor cause the processor to:
receive, via the user interface of the entity application, a user input from the user device associated with the a change in the one or more events associated with the user;
generate at least one new task associated with the change based on receiving the user input from the user; and
store the at least one new task in the data store.

9. The system of claim 7, wherein the module further comprises executable instructions that when executed by the processor cause the processor to:
identify a plurality of users assigned to each of the plurality of associates of the entity;
extract historical activity from activity log associated with each of the plurality of users, wherein the historical activity is related to the at least one priority and the one or more events associated with each of the plurality of users;
extract life plan details associated with each of the plurality of users, wherein the life plan details comprise at least one tip and the at least one task associated with the at least one priority and the one or more events;
display the historical activity and the life plan details on an associate dashboard of an associate device, via a life plan associate interface;
identify that a first associate of the plurality of associates has an appointment for a plan conversation with a first user of the plurality of users associated with the first associate;
trigger one or more alerts associated with the historical activity and the life plan details associated with the first user on the associate dashboard;
receive a life plan input, via the life plan associate interface, from the associate, wherein the life plan input is based on the plan conversation with the first user; and
update the activity log associated with the first user based on the life plan input.

10. A computer program product for providing tailored solutions to facilitate execution of priorities and events, the computer program product comprising at least one non-transitory computer-readable medium having computer-readable program code portions embodied therein, the computer-readable program code portions comprises one or more executable portions for:
identifying one or more resource pools associated with a user of an entity;
extracting information associated with the one or more resource pools of the user;
identifying one or more plan conversations linked with the user, wherein the one or more plan conversations are linked to the user by a plurality of associates of the entity;
extracting the one or more plan conversations associated with the user;
determining, via an artificial intelligence engine, at least one priority based on the one or more plan conversations and the extracted information associated with the one or more resource pools;
generating, via the artificial intelligence engine, at least one tip associated with the at least one priority;
displaying the at least one tip via a user interface on a user device associated with the user, wherein the user interface is associated with an entity application; and
in response to displaying the at least one tip, receiving one or more actions from the user.

11. The computer program product of claim 10, wherein the computer-readable program code portions comprises one or more executable portions for:
determining, via the artificial intelligence engine, that the extracted information associated with the one or more resource pools and the one or more plan conversations is not sufficient to identify the at least one priority;
generating, via the artificial intelligence engine, a questionnaire based on the extracted information associated with the one or more resource pools;
storing the questionnaire in a data store;
identifying that the user has accessed the entity application; and
in response to identifying that the user has accessed the entity application, extracting the questionnaire stored in the data store and transmit control signals to the user device to display the questionnaire via the user interface.

12. The computer program product of claim 11, wherein the computer-readable program code portions comprises one or more executable portions for:
receiving one or more options associated with the questionnaire from the user device, wherein the user submits the one or more options to the questionnaire via the user interface;
identifying the at least one priority associated with the user based on the one or more options received from the user;
generating, via the artificial intelligence engine, the at least one tip associated with the at least one priority; and
displaying the at least one tip via the user interface on the user device.

13. The computer program product of claim 10, wherein the computer-readable program code portions comprises one or more executable portions for:
receiving, via the user interface of the entity application, a user input from the user device associated with the a change in the at least one priority associated with the user;
generating at least one new tip associated with the change based on receiving the user input from the user; and
storing the at least one new tip in the data store.

14. The computer program product of claim 10, wherein the computer-readable program code portions comprises one or more executable portions for:
identifying one or more events associated with the user, via an event service engine, based on the extracted information associated with the one or more resource pools or the one or more plan conversation;
generating, via the artificial intelligence engine, at least one task associated with each of the one or more events;
storing the at least one task associated with each of the one or more events in the data store;
identifying that the user has accessed the entity application;
in response to identifying that the user has accessed the entity application, extracting the at least one task stored in the data store and display the at least one task, via the user interface, on the user device.

15. The computer program product of claim 14, wherein the computer-readable program code portions comprises one or more executable portions for:
receiving, via the user interface of the entity application, a user input from the user device associated with the a change in the one or more events associated with the user;
generating at least one new task associated with the change based on receiving the user input from the user; and
storing the at least one new task in the data store.

16. The computer program product of claim 14, wherein the computer-readable program code portions comprises one or more executable portions for:
identifying a plurality of users assigned to each of the plurality of associates of the entity;
extracting historical activity from activity log associated with each of the plurality of users, wherein the historical activity is related to the at least one priority and the one or more events associated with each of the plurality of users;
extracting life plan details associated with each of the plurality of users, wherein the life plan details comprise at least one tip and the at least one task associated with the at least one priority and the one or more events;
displaying the historical activity and the life plan details on an associate dashboard of an associate device, via a life plan associate interface;
identifying that a first associate of the plurality of associates has an appointment for a plan conversation with a first user of the plurality of users associated with the first associate;
triggering one or more alerts associated with the historical activity and the life plan details associated with the first user on the associate dashboard;
receiving a life plan input, via the life plan associate interface, from the associate, wherein the life plan input is based on the plan conversation with the first user; and
updating the activity log associated with the first user based on the life plan input.

17. A computer implemented method for providing tailored solutions to facilitate execution of priorities and events, the method comprising:
identifying one or more resource pools associated with a user of an entity;
extracting information associated with the one or more resource pools of the user;
identifying one or more plan conversations linked with the user, wherein the one or more plan conversations are linked to the user by a plurality of associates of the entity;
extracting the one or more plan conversations associated with the user;
determining, via an artificial intelligence engine, at least one priority based on the one or more plan conversations and the extracted information associated with the one or more resource pools;
generating, via the artificial intelligence engine, at least one tip associated with the at least one priority;
displaying the at least one tip via a user interface on a user device associated with the user, wherein the user interface is associated with an entity application; and
in response to displaying the at least one tip, receiving one or more actions from the user.

18. The computer implemented method of claim 17, wherein the method further comprises:
determining, via the artificial intelligence engine, that the extracted information associated with the one or more resource pools and the one or more plan conversations is not sufficient to identify the at least one priority;
generating, via the artificial intelligence engine, a questionnaire based on the extracted information associated with the one or more resource pools;
storing the questionnaire in a data store;
identifying that the user has accessed the entity application; and
in response to identifying that the user has accessed the entity application, extracting the questionnaire stored in the data store and transmit control signals to the user device to display the questionnaire via the user interface.

19. The computer implemented method of claim 18, wherein the method further comprises:
receiving one or more options associated with the questionnaire from the user device, wherein the user submits the one or more options to the questionnaire via the user interface;
identifying the at least one priority associated with the user based on the one or more options received from the user;
generating, via the artificial intelligence engine, the at least one tip associated with the at least one priority; and
displaying the at least one tip via the user interface on the user device.

20. The computer implemented method of claim 17, wherein the method further comprises:
identifying one or more events associated with the user, via an event service engine, based on the extracted information associated with the one or more resource pools or the one or more plan conversation;
generating, via the artificial intelligence engine, at least one task associated with each of the one or more events;
storing the at least one task associated with each of the one or more events in the data store;
identifying that the user has accessed the entity application;
in response to identifying that the user has accessed the entity application, extracting the at least one task stored in the data store and display the at least one task, via the user interface, on the user device.
